(19) United States
(12) Patent Application Publication
(10) Pub. No.: US 2026/0316771 A1
(43) Pub. Date: Oct. 15, 2026

(54) SYSTEM AND METHOD FOR SELECTING VEHICLE CONTROL MODE

(71) Applicant: JAGUAR LAND ROVER LIMITED, Coventry, Warwickshire (GB)

(72) Inventors: Mike MENZIES, Coventry, West Midlands (GB); Joe WALSH, Stratford-Upon-Avon, Warwickshire (GB); Adrian YOUNG, Coventry, West Midlands (GB)

(21) Appl. No.: 19/481,074

(22) PCT Filed: Apr. 24, 2024
(86) PCT No.: PCT/EP2024/061265

§ 371 Date: Nov. 3, 2025

(30) Foreign Application Priority Data
May 4, 2023 (GB) 2306573.3

(51) Int. Cl. B60W 50/08; B60W 30/182

(52) U.S. Cl. CPC B60W 50/082; B60W 30/182; B60W 2520/04; B60W 2520/10; B60W 2520/28; B60W 2552/05

(57) ABSTRACT

Aspects of the present invention relate to a system for a vehicle having at least one vehicle subsystem. The system includes a subsystem controller for controlling at least one vehicle subsystem in a plurality of subsystem control modes. A switching device is provided for switching between a manual response mode and an automatic response mode. One or more of a vehicle detection system (VDS) and a vehicle sensor system (VSS) is provided for generating a signal from which at least one terrain condition indicator is derived. A processor is configured to evaluate the at least one terrain condition indicator and for providing an output indicative of the subsystem control mode which is most appropriate. The system is operable to operate in the most appropriate subsystem control mode if a subsystem control mode has been selected which is not consistent with the most appropriate subsystem control mode.

### TECHNICAL FIELD

The present disclosure relates to a system and method for selecting vehicle control mode. Aspects of the invention relate to a system, a vehicle, a vehicle control unit, a method for selecting a vehicle subsystem control mode and a non-transitory computer-readable medium.

### BACKGROUND

It is known to provide a system for selecting different control modes for subsystems provided on a vehicle. The subsystem control modes may, for example, provide different control strategies depending on the terrain type on which the vehicle is operating. The subsystem control modes may be selected automatically by a subsystem controller or may be selected manually by a driver of a vehicle. The driver may be able to switch between a manual response mode and an automatic response mode. If the manual response mode is selected, the driver may omit to change the control mode to match the current terrain type. For example, the driver may manually select a specific control mode for one driving situation but omit to switch to a different control mode when the vehicle is operating in a different terrain type. As a result, the selected control mode may not be appropriate for the current operating conditions.

It is an aim of the present invention to address one or more of the disadvantages associated with the prior art.

### SUMMARY OF THE INVENTION

Aspects and embodiments of the invention provide a system, a vehicle, a vehicle control unit, a method and a non-transitory computer-readable medium as claimed in the appended claims.

According to an aspect of the present invention there is provided a system for a vehicle having at least one vehicle subsystem, the system comprising:
a subsystem controller for controlling at least one vehicle subsystem in a plurality of subsystem control modes, each of which control modes corresponds to one or more different terrain types for the vehicle; a switching device for switching between a manual response mode in which one of the subsystem control modes is selected manually and an automatic response mode in which the subsystem controller automatically selects an appropriate subsystem control mode;
   one or more of a vehicle detection system and a vehicle sensor system for generating a signal from which at least one terrain condition indicator is derived;
a processor configured to evaluate the at least one terrain condition indicator to determine the extent to which each of the subsystem control modes is appropriate and for providing an output indicative of the subsystem control mode which is most appropriate, wherein the subsystem controller is operable in the automatic response mode to select a subsystem control mode in dependence on the output; and wherein the system is operable to operate in the subsystem control mode determined to be most appropriate if a subsystem control mode has been selected by the driver in the manual response mode which is not consistent with the subsystem control mode determined to be most appropriate. The subsystem controller may be operable to select the subsystem control mode determined to be most appropriate. The subsystem controller may thereby override the manually selected subsystem control mode if an inconsistency is identified. The subsystem control mode selected manually by the driver may be overruled at least in certain operating conditions. For example, the subsystem control mode selected by the driver may be overruled if the system determines that the vehicle is stuck or is at risk of becoming stuck. The automatic response mode is operable to determine an appropriate subsystem control mode in dependence on the at least one terrain condition indicator. The appropriate subsystem control mode can be selected automatically, thereby overriding the manually selected subsystem control mode. The selection of the appropriate subsystem control mode may reduce the likelihood of the vehicle becoming stuck and/or may facilitate self-recovery of the vehicle from a stuck condition. The system may subsequently revert to the manually selected subsystem control mode, for example if the vehicle is no longer stuck or the risk of becoming stuck has reduced. At least in certain embodiments, the manually selected subsystem control mode can be reselected without a driver input.

If the subsystem control mode selected in the manual response mode differs from the subsystem control mode determined to be most appropriate, the system is configured to operate in the subsystem control mode determined to be most appropriate. The system is configured to implement (i.e. to activate or to engage) the selected subsystem control mode automatically. The system may be configured to switch from the subsystem control mode selected by the driver in the manual response mode to the subsystem control mode determined to be most appropriate. The switch to the subsystem control mode determined to be most appropriate may be performed automatically, thereby selecting an appropriate subsystem control mode without a user input. At least in certain embodiments, the system is operable to ensure that the appropriate subsystem control mode is selected. The selection of the subsystem control mode may help to ensure that an appropriate control strategy is selected for the vehicle systems for the current terrain type. The system may override the subsystem control mode selected in the manual response mode by the driver, for example if the selected subsystem control mode is determined to be less appropriate. At least in certain embodiments the selection of the appropriate subsystem control mode provides improved vehicle control. The selection of the appropriate subsystem control mode may reduce wear on the vehicle, for example allowing reduced use of the brakes, clutch and torque generating machine.

The system may operate in the subsystem control mode determined to be most appropriate temporarily. The system may continue to operate in the manual response mode while operating in the subsystem control mode determined to be most appropriate. The system may be configured to revert to the subsystem control mode selected by the driver. For example, the system may revert to the driver-selected subsystem control mode after a predetermined time period. The system may thereby operate in the manual response mode selected by the driver without requiring further input from the driver. Alternatively, the system may be configured to revert to the driver-selected subsystem control mode in dependence on a change in the operating condition or the operating state of the vehicle. For example, the system may revert to the driver-selected subsystem control mode when the subsystem control mode determined to be most appropriate is the same as or is consistent with the driver-selected subsystem control mode.

Alternatively, the system may remain in the subsystem control mode determined to be most appropriate. The system may remain in the automatic mode selection and continue to select the subsystem control mode determined to be appropriate. The automatic mode selection may be engaged automatically without driver input. The driver may subsequently re-select the manual response mode.

The subsystem controller may be operable to switch from the manual response mode to the automatic response mode if the subsystem control mode selected by the driver in the manual response mode is not consistent with the subsystem control mode determined to be most appropriate. The system may be configured to operate in the subsystem control mode determined to be most appropriate while the system is operating in the automatic response mode. The subsystem control mode determined to be most appropriate may be changed automatically while the system is operating in the automatic response mode.

The switch to the automatic response mode may be temporary. The system may be operable to switch from the automatic response mode back to the manual response mode upon expiry of a predetermined time period. The system may be operable to switch from the automatic response mode back to the manual response mode upon a determination that the subsystem control mode selected by the driver in the manual response mode is consistent with the subsystem control mode determined to be most appropriate. Alternatively, the system may remain in the automatic response mode subject. The manual response mode may be re-engaged in dependence on a driver selection of the manual response mode.

The subsystem controller may be configured to monitor an operating condition of one or more vehicle subsystems. The system may be operable to operate in the subsystem control mode determined to be most appropriate in dependence on a determination that the monitored operating condition of the one or more vehicle systems is outside a predetermined operating range. The operating condition may, for example, be an operating temperature. The operating condition may be an operating temperature of a clutch pack in a drivetrain.

The subsystem control mode determined to be most appropriate may be selected in dependence on the evaluation of the at least one terrain condition indicator. The at least one terrain condition indicator may enable an assessment of the terrain type. The assessment of the terrain type may facilitate determination of the appropriate subsystem control mode for the current operating conditions encountered by the vehicle.

The system may be configured to operate in the subsystem control mode determined to be appropriate in dependence on an operating condition or an operating state of the vehicle. The system may, for example, automatically select the subsystem control mode determined to be most appropriate in dependence on a determination that the vehicle is in a stuck condition, i.e. in dependence on a determination that the vehicle is stuck fast. The system may be configured to determine that the vehicle is in one of: a vehicle stuck condition (i.e. the vehicle is stuck fast), and a vehicle not stuck condition (i.e. the vehicle is not stuck fast). The selection of the appropriate subsystem control mode may reduce the likelihood of the vehicle becoming stuck and/or may facilitate self-recovery of the vehicle from a stuck condition.

The determination that the vehicle is in a stuck condition may comprise assessing an operating condition of one or more of the vehicle subsystems; and/or an operating state of the vehicle. Alternatively, or in addition, the determination that the vehicle is in a stuck condition may comprise monitoring the at least one terrain condition indicator.

The determination that the vehicle is in a stuck condition may comprise determining that each of the following set of conditions is satisfied:
i. The longitudinal speed of the vehicle is substantially equal to zero (0); and
ii. One of a first sum and a second sum is equal to zero (0) or is less than a first threshold; and the other one of the first and second sums is greater than zero (0) or is greater than a second threshold; wherein the first sum is the sum of the front wheel speeds and the second sum is the sum of the rear wheel speeds.

The determination of the first and second sums facilitates monitoring of the behaviour of the wheels on each axle of the vehicle.

The determination that the vehicle is in a stuck condition may comprise determining that each of the following conditions is satisfied:
i. The longitudinal speed of the vehicle is at least substantially equal to zero;
ii. The wheel speed of at least one of the one or more wheel on the first axle or a first sum of the wheel speeds of the wheels on the first axle is less than or equal to a first threshold value; and
iii. The wheel speed of at least one of the one or more wheel on the second axle or a second sum of the wheel speeds of the wheels on the second axle is greater than a second threshold value.

The wheel speed of the one or more wheel on each axle may be compared to the respective first and second threshold values. This facilitates assessment of the operating state of the vehicle.

The first sum may represent the combined (i.e. total) wheel speed of each of the wheels on the first axle. By comparing the first sum of the wheel speeds to the first threshold, the control system allows for variations between the wheel speeds of the wheels on the first axle. The second sum may represent the combined (i.e. total) wheel speed of each of the wheels on the second axle. By comparing the second sum of the wheel speeds to the second threshold, the control system allows for variations between the wheel speeds of the wheels on the second axle.

One of the first and second threshold values may be defined as zero (0); and the other one of the first and second threshold values may be defined as a discrete value greater than zero (0). The second threshold value may be greater than the first threshold value.

The control system may be configured to determine that the vehicle is in the stuck condition in dependence on the determination that the difference between the first and second sums is greater than a predetermined difference threshold. The determination of a wheel speed differential which is greater than the difference threshold may help to avoid or to reduce the identification of false positives. The control system may subtract the first sum from the second sum. Alternatively, the control system may subtract the second sum from the first sum. The magnitude of the difference between the first and second sums may be compared to the difference threshold.

The control system may be configured to determine that the vehicle is in the stuck condition in dependence on the determination that the difference between the wheel speed of the one or more wheel on the first axle and the wheel speed of the one or more wheel on the second axle is greater than a predetermined difference threshold. The determination of a wheel speed differential which is greater than the difference threshold may help to avoid or to reduce the identification of false positives. Where a plurality of wheel speeds is available, the difference between the slowest wheel speed on the first axle and the fastest wheel speed on the second axle may be compared to the predetermined difference threshold.

The determination that the vehicle is in a stuck condition may optionally comprise determining that one or more of the following conditions is also satisfied:
i. A requested vehicle braking force is zero (0);
ii. A current selected transmission ratio is a forward drive ratio (not a reverse or neutral drive ratio); and
iii. A torque request is greater than a torque threshold.

By assessing one or more additional conditions, the system may more accurately identify a vehicle stuck condition. These conditions may help to help to determine whether the driver is attempting to drive the vehicle.

The system may be configured to operate in the subsystem control mode determined to be most appropriate while the vehicle stuck condition is identified. The system may be configured to operate in the subsystem control mode selected by the driver when the vehicle stuck condition is not identified. The system may be configured to select the subsystem control mode determined to be most appropriate in dependence on an identification of the vehicle stuck condition. The system may revert to the subsystem control mode selected by the driver in dependence on a determination that the vehicle is not in a stuck condition.

The system may be configured to switch from operation in the manual response mode to operation in the automatic response mode in dependence on an identification of the vehicle stuck condition. The system may remain in the automatic response mode while the vehicle stuck condition is identified. The system may be configured to switch from operation in the automatic response mode back to operation in the manual response mode in dependence on the identification of the vehicle not stuck condition (or the absence of the vehicle stuck condition).

The system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to:
evaluate the at least one terrain condition indicator to determine the extent to which each of the subsystem control modes is appropriate and for providing an output indicative of the subsystem control mode which is most appropriate, wherein the subsystem controller is operable in the automatic response mode to select a subsystem control mode in dependence on the output; and
   to operate in the subsystem control mode determined to be most appropriate if a subsystem control mode has been selected by the driver in the manual response mode which is not consistent with the subsystem control mode determined to be most appropriate. The selection of the appropriate subsystem control mode may reduce the likelihood of the vehicle becoming stuck and/or may facilitate self-recovery of the vehicle from a stuck condition.

The evaluation of the at least one terrain condition indicator to determine the appropriate subsystem control mode may be performed by a first controller, for example comprising a first processor. A second controller, for example comprising a second processor, to assess the consistency of the subsystem control mode selected by the driver in the manual response mode and the subsystem control mode determined to be most appropriate. The second controller may select the subsystem control mode determined to be most appropriate in dependence on the identification of an inconsistency. The first and second controllers may be combined into a single controller. It will be understood that the system may comprise additional controllers.

According to an aspect of the present invention there is provided a system for a vehicle having at least one vehicle subsystem, the system comprising:
a subsystem controller for controlling at least one vehicle subsystem in a plurality of subsystem control modes, each of which control modes corresponds to one or more different terrain types for the vehicle; and
a processor configured to evaluate at least one terrain condition indicator to determine the extent to which each of a plurality of subsystem control modes is appropriate and for providing an output indicative of the subsystem control mode which is most appropriate, wherein the subsystem controller is operable to select a subsystem control mode in dependence on the output;
wherein the system is operable to operate in the subsystem control mode determined to be most appropriate if a subsystem control mode has been selected by the driver which is not consistent with the subsystem control mode determined to be most appropriate. The subsystem controller may be operable to select the subsystem control mode determined to be most appropriate, thereby overriding the manually selected subsystem control mode if an inconsistency is identified. The selection of the appropriate subsystem control mode may reduce the likelihood of the vehicle becoming stuck and/or may facilitate self-recovery of the vehicle from a stuck condition.

According to a further aspect of the present invention there is provided a vehicle comprising a system as described herein. The vehicle may comprise one or more subsystems. The system may be configured to select the subsystem control mode to control operation of the one or more subsystems on the vehicle.

According to a further aspect of the present invention there is provided a vehicle control unit for controlling at least one vehicle subsystem of a vehicle in a plurality of subsystem control modes, each of which corresponds to one or more different terrain types for the vehicle, the vehicle control unit being configured to:
receive a signal from one or more vehicle sensors; derive from the signal at least one terrain condition indicator; and evaluate the at least one terrain condition indicator to determine the extent to which each of the subsystem control modes is appropriate;
wherein the vehicle control unit is operable in an automatic response mode to select a subsystem control mode in dependence on the subsystem control mode which is determined to be the most appropriate, the vehicle control unit being switchable from the automatic response mode to a manual response mode in which the subsystem control mode is selected by the driver manually; and
wherein the vehicle control unit is configured to operate in the subsystem control mode determined to be most appropriate if a subsystem control mode has been selected by the driver in the manual response mode which is not consistent with the subsystem control mode determined to be the most appropriate subsystem control mode by the vehicle control unit. The selection of the appropriate subsystem control mode may reduce the likelihood of the vehicle becoming stuck and/or may facilitate self-recovery of the vehicle from a stuck condition.

The vehicle control unit may be configured to switch to the automatic response mode if the subsystem control mode selected by the driver in the manual response mode is not consistent with the subsystem control mode determined to be most appropriate. The selection of the subsystem control mode determined to be most appropriate may be implemented automatically when the automatic control mode is selected.

The vehicle control unit may comprise a subsystem controller for controlling the at least one vehicle subsystem. The subsystem controller may be configured to control the at least vehicle subsystem in one of a plurality of subsystem control modes, each of which control modes corresponds to one or more different terrain types for the vehicle. The subsystem controller may be selectively operable in the manual response mode and the automatic response mode.

According to a further aspect of the present invention there is provided a method of controlling operation of at least one vehicle subsystem of a vehicle, the method comprising:
controlling the at least one vehicle subsystem in a plurality of subsystem control modes, each of the subsystem control modes corresponding to one or more different terrain types for the vehicle;
   selecting one of a manual response mode for manually selecting one of the subsystem control modes and an automatic response mode in which an appropriate one of the subsystem control modes is selected automatically;
determining at least one terrain condition indicator; and
   evaluating the at least one terrain condition indicator to determine the extent to which each of the subsystem control modes is appropriate and determining which of the subsystem control modes is most appropriate and automatically selecting the subsystem control mode determined to be most appropriate when the automatic response mode is selected;
   wherein the method comprises operating in the subsystem control mode determined to be most appropriate if a subsystem control mode has been selected by the driver in the manual response mode which is not consistent with the subsystem control mode determined to be most appropriate.

The method may comprise switching from the manual response mode to the automatic response mode. The selection of the subsystem control mode determined to be most appropriate may be implemented automatically when operating in the automatic response mode.

According to an aspect of the present invention there is provided a method of controlling operation of at least one vehicle subsystem of a vehicle, the method comprising:
controlling the at least one vehicle subsystem in a plurality of subsystem control modes, each of which control modes corresponds to one or more different terrain types for the vehicle; and
evaluating at least one terrain condition indicator to determine the extent to which each of a plurality of subsystem control modes is appropriate and automatically selecting the subsystem control mode determined to be most appropriate;
wherein the method comprises operating in the subsystem control mode determined to be most appropriate if a subsystem control mode has been selected by the driver which is not consistent with the subsystem control mode determined to be most appropriate.

According to an aspect of the present invention there is provided a non-transitory computer-readable medium having a set of instructions stored therein which, when executed, cause a processor to perform the method(s) described herein.

According to an aspect of the present invention there is provided computer software that, when executed, is arranged to perform the method(s) described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle incorporating a control system for selecting a subsystem control mode in accordance with an embodiment of the present invention;

FIG. 2 shows a plan view of the vehicle shown in FIG. 1 incorporating the control system configured to select the subsystem control mode;

FIG. 3 shows a schematic representation of a vehicle control unit for use in the control system according to an embodiment of the present invention;

FIG. 4 shows a block diagram to illustrate a vehicle control system including various vehicle subsystems under the control of the control system;

FIG. 5 shows a block diagram of human machine interface (HMI) elements forming part of the control system;

FIG. 6 shows a schematic representation of a control unit for identifying a vehicle stuck condition in accordance with a further aspect of the present invention;

FIG. 7 shows a block diagram representing operation of the control system to switch automatically from a user-selected manual response mode to an automatic control mode;

FIG. 8 shows a block diagram representing the identification of a vehicle stuck condition when the vehicle is in a stuck condition; and

FIG. 9 illustrates a method of controlling selection of a subsystem control mode in accordance with an embodiment of the present invention.

### DETAILED DESCRIPTION

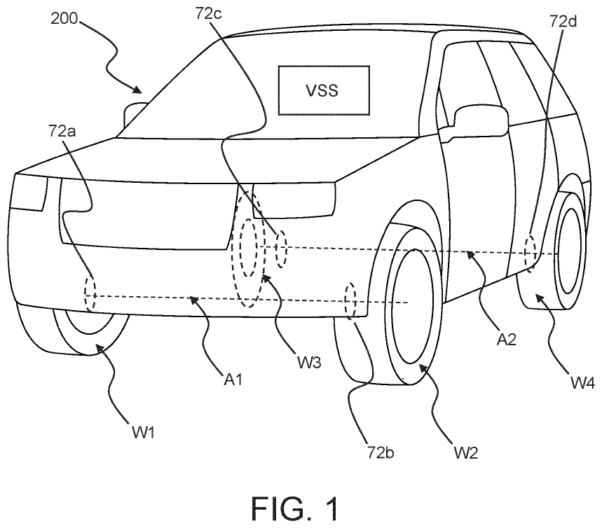

A system 1 in accordance with an embodiment of the present invention is described herein with reference to the accompanying Figures. As shown in FIG. 1, the system 1 is installed in a vehicle 200. As described herein, the system 1 comprises a vehicle control unit (VCU) 10 for controlling operation of a plurality of vehicle subsystems (denoted generally by the reference numeral 12).

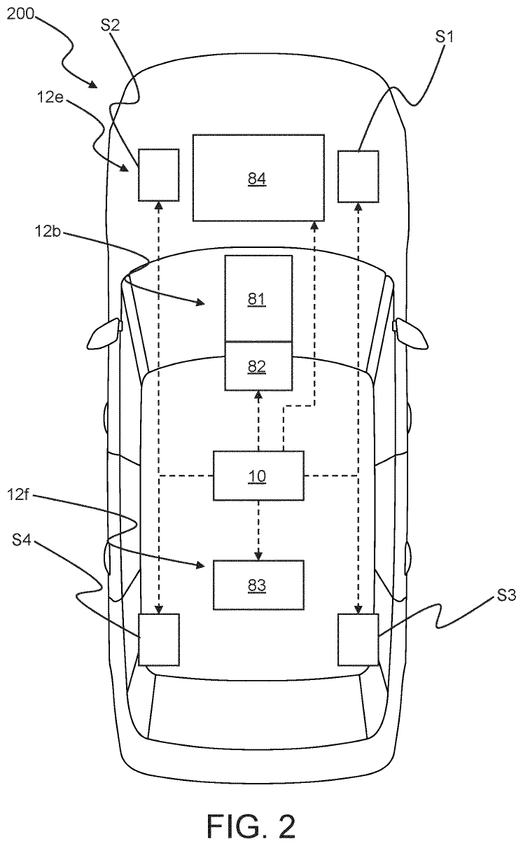

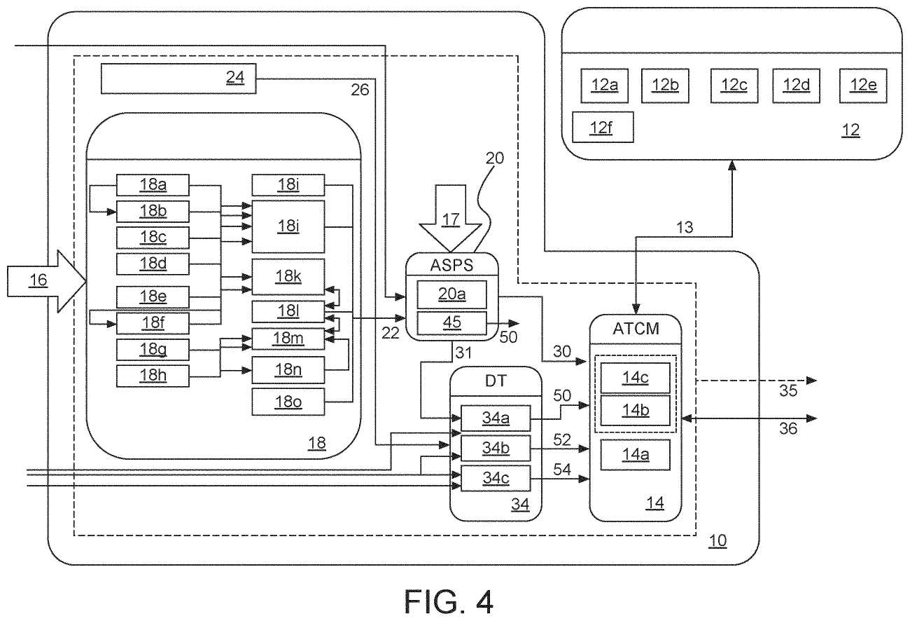

FIGS. 1 and 2 show the VCU 10 for the vehicle 200. The vehicle 200 has first and second front wheels W1, W2 disposed on a front axle A1; and first and second rear wheels W3, W4 disposed on a rear axle A2. The vehicle 200 is intended to be suitable for off-road use, that is for use on terrain other than regular tarmac or concrete road surfaces. The VCU 10 controls a plurality of vehicle subsystems 12, shown schematically in FIG. 4, including, but not limited to, a propulsion (or engine) management system 12a, a transmission system 12b, a steering system 12c, a brakes system 12d, a suspension system 12e and a differential system 12f. Although five subsystems are illustrated as being under the control of the VCU 10, in practice a greater number of vehicle subsystems may be included on the vehicle and may be under the control of the VCU 10. The VCU 10 includes a subsystem controller in the form of a subsystem controller 14 (ATCM). The subsystem controller 14 comprises a controller having one or more electronic processor having at least one input and at least one output. The subsystem controller 14 provides control signals via signal line 13 to each of the vehicle subsystems 12 to control the subsystems in a manner appropriate to the driving condition, such as the terrain on which the vehicle is travelling (referred to as the terrain condition). The vehicle subsystems 12 also communicate with the subsystem controller 14 via signal line 13 to feedback information on subsystem status.

As shown in FIG. 2, the transmission system 12b comprises a transmission 81 which is operable selectively to engage one of a plurality of drive ratios. The drive ratios typically comprise a plurality of forward drive ratios, a reverse drive ratio and a neutral (or disengaged) drive ratio. The transmission system 12b in the present embodiment also includes a transfer case 82 operable selectively to engage a low drive ratio. The transfer case 82 may be omitted from the transmission system 12b. The suspension system 12e in the present embodiment is an adjustable-height suspension. The suspension system 12e may, for example, be an air suspension or a mechanically adjustable suspension. The suspension system 12e comprises a plurality of adjustable-height suspension units S1-4, the adjustable-height suspension units S1-4 being associated with the respective wheels W1-W4 of the vehicle 200. The height of the suspension system 12e may be controlled, for example by controllably inflating and deflating one or more air bladder provided in the suspension units S14, to raise or lower the vehicle body. The differential system 12f comprises one or more lockable differential, for example one or more of a centre differential, a rear differential and a front differential. The differential system 12f in the present embodiment comprises a centre differential (denoted by the reference numeral 83 in FIG. 2). The propulsion (or engine) management system 12a is configured to control operation of a torque generating machine (denoted by the reference numeral 84 in FIG. 2), such as an internal combustion engine or an electric traction motor.

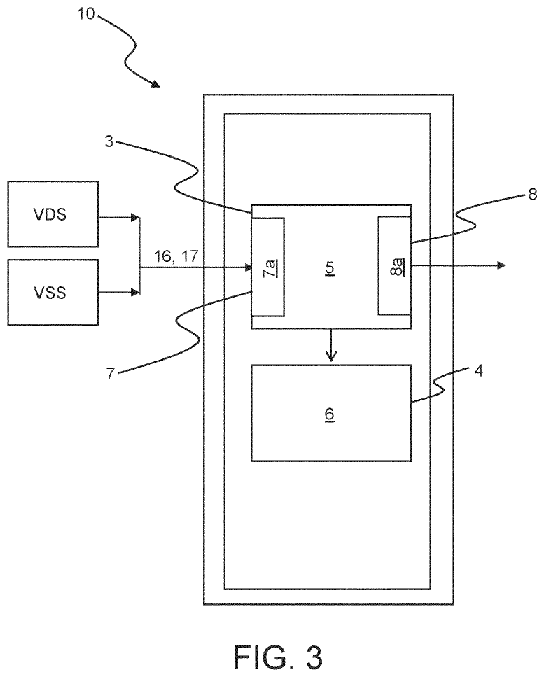

A schematic representation of the VCU 10 is shown in FIG. 3. The VCU 10 comprises processing means 3 and memory means 4. The processing means 3 may be one or more electronic processing device 5 which operably executes computer-readable instructions. The memory means 4 may be one or more memory device 6. The memory means 4 is electrically coupled to the processing means 3. The memory means 4 is configured to store instructions, and the processing means 3 is configured to access the memory means 4 and execute the instructions stored thereon.

The processing means 3 comprises an input means 7 and an output means 8. The input means 7 comprises an electrical input 7a. The output means 8 comprises an electrical output 8a. The VCU 10 receives a plurality of signals, represented generally at 16 and 17, which are received from a plurality of vehicle sensors and are representative of a variety of different parameters associated with vehicle motion and status. As described in further detail below, the signals 16, 17 provide, or are used to calculate, a plurality of driving condition indicators (also referred to as terrain indicators) which are indicative of the nature of the condition in which the vehicle is travelling. One advantageous feature of the invention is that the VCU 10 determines the most appropriate subsystem control mode for the various vehicle subsystems 12 on the basis of the terrain indicators, and automatically controls the subsystems accordingly.

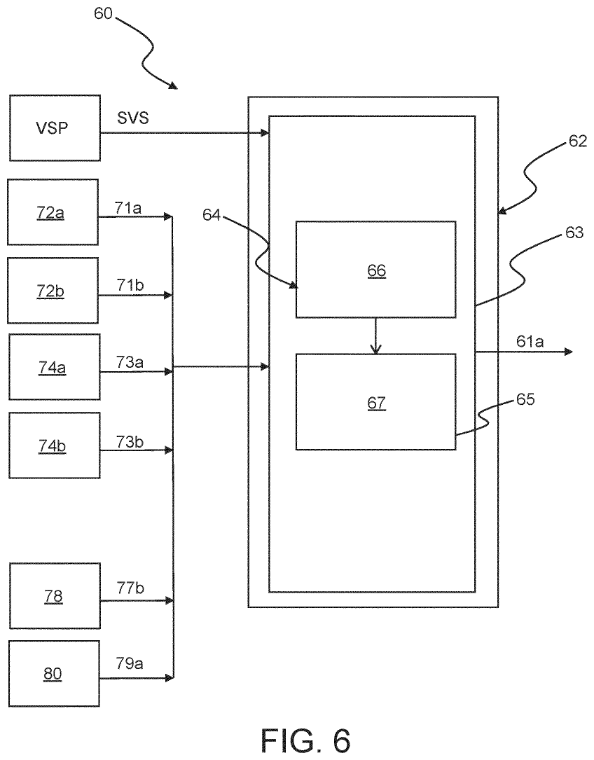

The sensors (denoted generally as a vehicle sensor system VSS in FIG. 3) on the vehicle include, but are not limited to, sensors which provide continuous sensor outputs 16 to the VCU 10, including wheel speed sensors 72a-d, an ambient temperature sensor, an atmospheric pressure sensor, tire pressure sensors, sensors, such as gyroscopic sensors, for measuring yaw, roll and pitch of the vehicle, a vehicle speed sensor VSP, a longitudinal acceleration sensor, an engine torque sensor (or engine torque estimator), a steering angle sensor, a steering wheel speed sensor, a gradient sensor (or gradient estimator), a lateral acceleration sensor on a stability control system (SCS), a brake pedal position sensor 78 (see FIG. 6), an acceleration pedal position sensor and longitudinal, lateral and vertical motion sensors. The vehicle speed sensor VSP comprises an inertial measurement unit, for example including one or more accelerometer. The vehicle speed sensor VSP in the present embodiment comprises an accelerometer configured to measure longitudinal acceleration of the vehicle 200. The vehicle speed sensor VSP is configured to output a vehicle speed signal SVS indicating the vehicle speed VLS. In the present embodiment the vehicle speed signal SVS indicates the longitudinal speed VLS of the vehicle 200. The vehicle speed signal SVS may indicate a magnitude of the longitudinal speed VLS of the vehicle.

In other embodiments, only a selection of the aforementioned sensors may be used.

The VCU 10 also receives a signal from the electronic power assisted steering unit (ePAS unit) of the vehicle to indicate the steering force that is applied to the wheels (steering force applied by the driver combined with steering force applied by the ePAS system).

The vehicle 200 is also provided with a plurality of sensors which provide discrete sensor outputs 16 to the VCU 10, including a cruise control status signal (ON/OFF), a transfer box status signal (whether the gear ratio is set to a HIGH range or a LOW range), a Hill Descent Control (HDC) status signal (ON/OFF), a trailer connect status signal (ON/OFF), a signal to indicate that the Stability Control System (SCS) has been activated (ON/OFF), a windscreen wiper signal (ON/OFF), air suspension status (Raised/High, Normal, or Low), and a Dynamic Stability Control (DSC) signal (ON/OFF).

The vehicle 200 may also be provided with one or more detection systems (denoted generally as a vehicle detection system VDS in FIG. 3) in the form of a camera system, a RADAR system or a LIDAR system. The camera system may, for example, include one or more camera sensors that form a part of a parking aid system on the vehicle. Alternatively, the cameras may be provided to give an indication of the nature of the terrain in the surrounding vicinity of the vehicle, but not necessarily the terrain immediately beneath the vehicle wheels. Further examples of the use of camera data in the present invention is described in further detail below.

In FIG. 4, the VCU 10 includes an evaluation means in the form of an estimator module 18 and a calculation and selection means in the form of a selector module 20. Initially the continuous sensor outputs 16 from the sensors are provided to the estimator module 18 whereas the discrete terrain condition indicators 17 are provided to the selector module 20.

The estimator module 18 comprises a controller having one or more electronic processor having at least one input and at least one output. The selector module 20 comprises a controller having one or more electronic processor having at least one input and at least one output. The subsystem controller 14, the estimator module 18 and the selector module 20 are implemented by the one or more electronic processing device 5 of the VCU 10. The subsystem controller 14, estimator module 18 and the selector module 20 may be implemented by the same electronic processing device 5 or by different electronic processing devices 5.

As shown schematically in FIG. 4, the estimator module 18 comprises a plurality of estimator modules dedicated to specific aspects of vehicle and vehicle sub-system behaviour. In the example shown, these modules comprise: wheel acceleration 18a; wheel inertia torque estimator 18b; vehicle longitudinal force 18c; aerodynamic drag estimator 18d; wheel longitudinal force estimator 18e; wheel slip detection 18f; lateral acceleration estimator 18g; vehicle yaw estimator 18h; wheel speed variation and corrugation detection 18i; surface rolling resistance 18j; wheel longitudinal slip or ‘breakaway torque’ 18k; surface friction or ‘mu’ plausibility check 18l; lateral surface friction or ‘mu’ estimation/rut detection 18m; steering force estimator 18n; and corrugation detection estimation 18o.

Within a first stage of the estimator module 18, various ones of the sensor outputs 16 are used to derive one or more terrain condition indicator 17. In a first stage of the estimator module 18, a vehicle speed is derived from the wheel speed sensors, wheel acceleration is derived from the wheel speed sensors, the longitudinal force on the wheels is derived from the vehicle longitudinal acceleration sensor, and the torque at which wheel slip occurs (if wheel slip occurs) is derived from the motion sensors to detect yaw, pitch and roll. Other calculations performed within the first stage of the estimator module 18 include the wheel inertia torque (the torque associated with accelerating or decelerating the rotating mass of the wheels), “continuity of progress” (the assessment of whether the vehicle is starting and stopping, for example as may be the case when the vehicle is travelling over rocky terrain), aerodynamic drag, yaw, and lateral vehicle acceleration.

The estimator module 18 also includes a second stage in which the following terrain indicators are calculated: surface rolling resistance (based on the wheel inertia torque, the longitudinal force on the vehicle, aerodynamic drag, and the longitudinal force on the wheels), the steering force on the steering wheel (based on the lateral acceleration and the output from the steering wheel sensor), the wheel longitudinal slip (based on the longitudinal force on the wheels, the wheel acceleration, SCS activity and a signal indicative of whether wheel slip has occurred), lateral friction (calculated from the measured lateral acceleration and the yaw versus the predicted lateral acceleration and yaw), and corrugation detection (high frequency, low amplitude wheel height excitement indicative of a washboard type surface).

The SCS activity signal is derived from several outputs from a Stability Control Systems (SCS) ECU (not shown), which contains the DSC (Dynamic Stability Control) function, the TC (Traction Control) function, ABS (anti-lock braking system) and HDC (hill descent control) algorithms, indicating DSC activity, TC activity, ABS activity, brake interventions on individual wheels, and engine torque reduction requests from the SCS ECU to the engine. All these indicate a slip event has occurred and the SCS ECU has taken action to control it. The estimator module 18 also uses the outputs from the wheel speed sensors 72a-d to determine a wheel speed variation and corrugation detection signal.

The VCU 10 also includes a road roughness module 24 for calculating the terrain roughness/corrugation based on the air suspension sensors (the ride height sensors) and the wheel accelerometers. A terrain indicator signal in the form of a road roughness output 26 is output from the road roughness module 24. Additionally, or alternatively, wheel articulation data may be provided to the road roughness module 24 by appropriate sensing means, such as suspension stroke transducers, such as continuously variable damping (CVD) sensors.

The estimates for the wheel longitudinal slip and the lateral friction estimation are compared with one another within the estimator module 18 as a plausibility check.

Calculations for wheel speed variation and corrugation output, the surface rolling resistance estimation, the wheel longitudinal slip and the corrugation detection, together with the friction plausibility check, are output from the estimator module 18 and provide terrain indicator signals 22, indicative of the nature of the terrain in which the vehicle is travelling, for further processing within the VCU 10.

The terrain indicator signals 22 from the estimator module 18 are provided to the selector module 20 for determining which of a plurality of vehicle subsystem control modes is most appropriate based on the indicators of the type of terrain in which the vehicle is travelling. The selector module 20 serves as an automatic special program selector (ASPS) and comprises an automatic special program selector (ASPS) algorithm, or probability algorithm 20a. The most appropriate subsystem control mode is determined by analyzing the probability that each of the different subsystem control modes is appropriate on the basis of the terrain indicator signals 22, 26 from the estimator module 18 and the road roughness module 24.

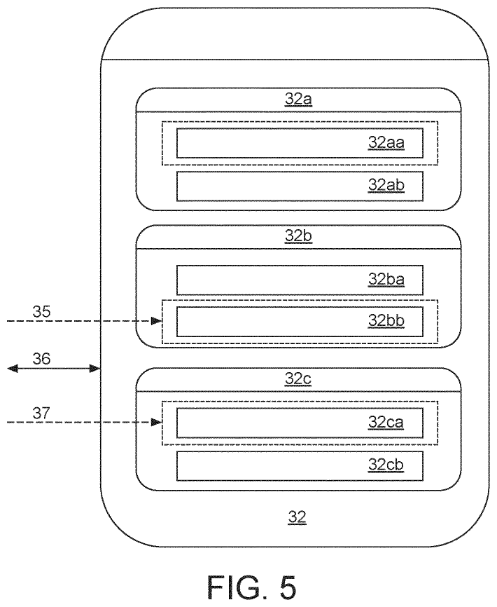

The vehicle subsystems 12 may be controlled automatically (referred to as the “automatic response mode”) in response to an output 30 from the selector module 20 and without the need for driver input. Alternatively, the vehicle subsystems 12 may be operated in response to a manual driver input (referred to as “manual response mode”) via a Human Machine Interface (HMI) module (see FIG. 5 but not shown in FIG. 1).

When operating in the automatic response mode, the selection of the most appropriate subsystem control mode is achieved by means of a three phase process:
(1) for each type of subsystem control mode, a calculation is performed of the probability that the subsystem control mode is suitable for the terrain over which the vehicle 200 is travelling, based on the terrain indicators;
(2) the integration of “positive differences” between the probability for the current subsystem control mode and the other subsystem control modes; and
(3) the program request to the subsystem controller 14 when the integration value exceeds a predetermined threshold or the current terrain subsystem control mode probability is zero.

The specific steps for phases (1), (2) and (3) will now be described in more detail.

In phase (1), the continuous terrain indicator signals in the form of the road roughness output 26 and the terrain indicator signals 22 from the estimator module 18 are provided to the selector module 20. The selector module 20 also receives the discrete terrain indicators 17 directly from various sensors on the vehicle, including the transfer box status signal (whether the gear ratio is set to a HIGH range or a LOW range), the DSC status signal, cruise control status (whether the vehicle's cruise control system is ON or OFF), and trailer connect status (whether or not a trailer is connected to the vehicle). Terrain indicator signals indicative of ambient temperature and atmospheric pressure are also provided to the selector module 20.

The probability algorithm 20a for calculating the most suitable subsystem control mode for the vehicle subsystems based on the discrete terrain indicators 17 received directly from the sensors and the continuous terrain indicators 22, 26 are calculated by the estimator module 18 and the road roughness module 24, respectively.

The subsystem control modes typically include a grass/gravel/snow control mode (GGS mode) that is suitable for when the vehicle is travelling in grass, gravel or snow terrain, a mud/ruts control mode (MR mode) which is suitable for when the vehicle is travelling in mud and/or rutted terrain, a rock crawl/boulder mode (RB mode) which is suitable for when the vehicle is travelling across rocky terrain such as a boulder field, a sand mode (Sand mode) which is suitable for when the vehicle is travelling in sand terrain (or deep soft snow) and a special programs OFF mode (SP OFF mode) which is a suitable compromise mode, or general mode, for all terrain conditions and especially vehicle travel on motorways and regular roadways.

The different terrain types are grouped according to the friction of the terrain and the roughness of the terrain. For example, it is appropriate to group grass, gravel and snow together as terrains that provide a low friction and a relatively smooth surface, and it is appropriate to group rock and boulder terrains together as they tend to be characterized by relatively high friction and very high roughness.

For each subsystem control mode, the probability algorithm 20a within the selector module 20 performs a probability calculation, based on the terrain indicators, to determine a probability that each of the different subsystem control modes is appropriate. The selector module 20 includes a tunable data map which relates the continuous terrain indicators 22, 26 (e.g. vehicle speed, road roughness, steering angle) to a probability that a particular subsystem control mode is appropriate. Each probability value typically takes a value of between 0 and 1. So, for example, the vehicle speed calculation may return a probability of 0.7 for the RB mode if the vehicle speed is relatively slow, whereas if the vehicle speed is relatively high the probability for the RB mode will be much lower (e.g. 0.2). This is because it is much less likely that a high vehicle speed is indicative that the vehicle is travelling over a rock or boulder terrain.

In addition, for each subsystem control mode, each of the discrete terrain indicators 17 (e.g. trailer connection status ON/OFF, cruise control status ON/OFF) is also used to calculate an associated probability for each of the subsystem control modes, GGS, RB, Sand, MR or SP OFF. So, for example, if cruise control is switched on by the driver of the vehicle, the probability that the SP OFF mode is appropriate is relatively high, whereas the probability that the MR subsystem control mode is appropriate will be lower.

For each of the different subsystem control modes, a combined probability value, Pb, is calculated based on the individual probabilities for that subsystem control mode, as described above, as derived from each of the continuous or discrete terrain indicators 17, 22, 26. In the following equation, for each subsystem control mode the individual probability as determined for each terrain indicator is represented by a, b, c, d . . . n. The combined probability value, Pb, for each subsystem control mode is then calculated as follows:

Pb=(a.b.c.d . . . N )/((a.b.c.d . . . N )+(1−a).(1−b).(1−c).(1−d) . . . (1−n))

Any number of individual probabilities may be input to the probability algorithm 20a and any one probability value input to the probability algorithm may itself be the output of a combinational probability function.

Once the combined probability value for each subsystem control mode has been calculated, the subsystem control program corresponding to the subsystem control mode with the highest probability is selected within the selector module 20 and an output 30 providing an indication of this is provided in the form of a control signal to the subsystem controller 14. The benefit of using a combined probability function based on multiple terrain indicators is that certain indicators may make a subsystem control mode (e.g. GGS or MR) more or less likely when combined together, compared with basing the selection on just a single terrain indicator alone.

A further control signal 31 from the selector module 20 may optionally be provided to a driver advice system in the form of a driver tutoring (DT) or driver advice module 34, to initiate driver tutoring routines, as described in further detail below. The driver advice module 34 is fed with data from multiple vehicle sub-systems pertaining to the status and behaviour of the vehicle and comprises a plurality of elements dedicated to key features for example: auto response 34a; suspension ride height and/or pressure settings 34b; and transfer box ratio setting 34c.

In phase (2), an integration process is implemented continually within the selector module 20 to determine whether it is necessary to change from the current subsystem control mode to one of the alternative subsystem control modes.

The first step of the integration process is to determine whether there is a positive difference between the combined probability value for each of the alternative subsystem control modes compared with the combined probability value for the current subsystem control mode.

By way of example, assume the current subsystem control mode is GGS with a combined probability value of 0.5. If a combined probability value for the sand control mode is 0.7, a positive difference is calculated between the two probabilities (i.e. a positive difference value of 0.2). The positive difference value is integrated with respect to time. If the difference remains positive and the integrated value reaches a predetermined change threshold (referred to as the change threshold), or one of a plurality of predetermined change thresholds, the selector module 20 determines that the current terrain subsystem control mode (for GGS) is to be updated to a new, alternative subsystem control mode (in this example, the sand control mode). An output 30 in the form of a control signal is then output from the selector module 20 to the subsystem controller 14 to initiate the sand subsystem control mode for the vehicle subsystems.

In phase (3), the probability difference is monitored and if, at any point during the integration process, the probability difference changes from a positive value to a negative value, the integration process is cancelled and reset to zero. Similarly, if the integrated value for one of the other alternative subsystem control modes (i.e. other than sand), reaches the predetermined change threshold before the probability result for the sand subsystem control mode, the integration process for the sand subsystem control mode is cancelled and reset to zero and the other alternative subsystem control mode, with a higher probability difference, is selected.

If a high speed of response is required, one consequence may be that a high and frequent number of subsystem control mode changes are implemented. In some circumstances, the high number of changes may be inappropriate or excessive. The rate of change of the subsystem control mode is affected by two elements of the calibration process: the combined probability values of each of the subsystem control modes and the integrated positive difference threshold for change (the change threshold). The problem of frequent subsystem control mode changes can be countered in one of two ways. If the change threshold is set to a relatively large value, it will take longer for any one subsystem control mode to switch to another. This strategy will have an effect on all subsystem control mode selections. Alternatively, by ensuring there is only a small difference between the data map probability values for the different subsystem control modes, for example by setting all values to be close to 0.5, it will take longer for a change in the subsystem control mode to be implemented compared with the situation where there is a large difference. If desired, this strategy can be used to affect the speed of response in relation to only selected ones of the terrain indicators and subsystem control modes.

The probability difference between the current subsystem control mode and all other subsystem control modes is monitored continually and the integrated value for each subsystem control mode is continually compared with the predetermined change threshold. The predetermined change threshold is calibrated offline, prior to vehicle running, and is stored in a memory of the selector module 20.

It is beneficial for the predetermined change threshold to be variable with the terrain indicator for surface roughness. In this way the frequency with which the subsystem control mode is changed can be altered, depending on the nature of the terrain roughness in which the vehicle is travelling. For example, if the vehicle is travelling on-road (e.g. on a regular smooth road surface), where the surface roughness is low, the change threshold is set to a relatively high value so that it takes longer for the integrated difference value to reach the threshold and so the subsystem control mode is changed less frequently. This avoids a subsystem control mode change if, for example, a vehicle mounts a curb for a short period of time on an otherwise straightforward journey on a regular road. Conversely, if the vehicle is travelling off-road, where the surface roughness is high, the change threshold is set to a lower value so that the subsystem control mode is changed more frequently to accommodate the genuine changes in terrain that warrant an adjustment to the subsystem control mode.

In an embodiment, one or more additional change thresholds may also be implemented for comparison with the integrated difference value, each of which is based on a different one of the terrain indicators. For example, another change threshold may be set dependent on vehicle rolling resistance. In this case the integrated difference value is compared with both thresholds (one for surface roughness and one for rolling resistance), and when a first one of the thresholds is crossed a change to the subsystem control mode is initiated.

If it is determined that the combined probability of the current subsystem control mode becomes zero, an output 30 in the form of a control signal is sent from the selector module 20 to the subsystem controller 14 to implement one of the other subsystem control modes corresponding to that with the highest combined probability. Primarily, this mode of change will be implemented to handle discrete terrain indicators which are indicative that it is no longer acceptable to remain in the current subsystem control mode. For example, if the driver selects cruise control, the subsystem control module will automatically set the probability for the MR mode and sand mode to zero. This is because the GGS mode and the SP OFF mode are the only suitable modes for the vehicle subsystems if the vehicle is in a cruise subsystem control mode. If the RB mode is selected at the time the driver selects cruise control, the probability for the RB mode is immediately set to zero and the subsystem controller immediately selects one of the other subsystem control modes with the highest probability.

Other indicators that may be used to apply constraints to the number of subsystem control modes that are “available” for selection include DSC ON/OF status (e.g. if the DSC status is turned OFF, the automatic response mode of operation is not available), trailer status and transfer box status (HIGH/LOW range).

There are a number of circumstances in which the integration process will be paused and the current integration value is stored in memory, rather than resetting to zero, as follows: (a) when the vehicle is travelling in reverse; (b) for a predetermined distance travelling forwards after a reverse motion; (c) when the vehicle is in park mode; (d) when the vehicle is travelling below a certain speed; (e) when the vehicle is changing gear; (f) when the vehicle is braking with zero throttle being applied; and (g) when active braking is taking place. For example, for option (b) above, the selector module 20 may be programmed so that, if it is determined that the RB mode has the highest combined probability value, the integration process is started as soon as the vehicle starts to move forwards after a reverse motion, rather than waiting for a predetermined distance.

The subsystem controller 14 will now be described in further detail. The subsystem controller 14 includes three functions; a validation, fault management and check function 14a, an algorithm 14b to allow switching between automatic operation and manual operation (as described in further detail below), and an interface algorithm 14c for the (HMI) module to support the automatic response mode of operation. The HMI module 32 is shown in more detail in FIG. 5.

The subsystem controller 14 provides output signals to the HMI module 32. A first output signal 35 provides a notification to the HMI module 32 as to whether the automatic response mode or the manual response mode is active. If the automatic response mode is active then a second output signal 36 is provided to notify the driver when the system is “optimizing” and a change in the subsystem control mode is taking place.

Referring to FIG. 5, the HMI module 32 provides an interface between the selector module 20 and the driver of the vehicle and includes a switching device 32a, a messaging module 32b and a High Level Display Function (HLDF) module 32c. The switching device 32a comprises a selector switch 32a for switching between the manual response mode and the automatic response mode. In the example shown in FIG. 5, the selector switch 32a includes a dedicated hardware switch 32aa and switchgear comprising or arranged to support an existing vehicle system 32ab. The messaging module 32b comprises: display communication means 32ba, arranged to manage and generate messages to an instrument pack display and communicate with other related vehicle sub-systems; and a driver advice generator 32bb, arranged to provide appropriate messages to the driver via the instrument pack display. The HLDF module 32c comprises modules for driver information feedback 32ca and for supporting existing vehicle based HLDF systems and functionality 32cb.

The HMI module 32 is arranged to allow the driver of the vehicle to override the automatic response mode and select the manual response mode of operation via the selector switch 32a. The HMI module 32 also provides advice to the driver regarding various vehicle configurations, including the transfer box setting (HI or LO range), the air suspension off-road ride height (Raised/High, Normal, or Low) and a notification of when it is desirable to select the automatic response mode of operation. The HLDF module 32c includes a plurality of graphical indicators (not shown) to indicate to the driver when there has been a change in the selected subsystem control mode when the system is operating in the automatic response mode (i.e. derived from the second output signal 36). Typically, for example, the HLDF module 32c may display a textual indication to the driver along the lines of “CONTROL MODE UPDATING”.

On start-up of the vehicle, the control system is in the automatic response mode and the selector module 20 continually performs the probability analysis described above to deduce which of the various subsystem control modes is most appropriate. The selector module 20 automatically adjusts the subsystem control mode so that the mode which is most appropriate is used to control the vehicle subsystems. The driver can deliberately override the automatic response mode by switching the system into the manual response mode via the selector switch 32a of the HMI module 32. The selector module 20 may also selectively override the manual response mode selection and activate the automatic response mode. As described herein, the selector module 20 may automatically switch from the manual response mode to the automatic response mode. The automatic response mode may, for example, be activated for a predetermined time period. Upon expiry of the predetermined time period, the selector module may revert to the manual response mode. Alternatively, the activation of the automatic response mode may be persistent, for example until the manual response mode is selected again in dependence on another driver input. The automated activation of the automatic response mode will now be described in more detail.

A plurality of the subsystem control modes are defined by the control system 1. One of the predefined subsystem control modes is selected to provide appropriate control of the vehicle subsystems 12. The subsystem control mode is selected in dependence on a driver input in the manual response mode; and is selected automatically in the automatic response mode. As described herein, the subsystem control modes may include one or more of the following: a grass/gravel/snow subsystem control mode (GGS mode), a mud/ruts subsystem control mode (MR mode), a rock crawl/boulder mode (RB mode), a sand mode (Sand mode) and a compromise or general mode.

The subsystem controller 14 comprises a mode validation unit 45 operable to generate an override signal 50 to override the subsystem control mode selected by the driver in the manual response mode. The override signal 50 may activate the automatic response mode and/or implement the subsystem control mode determined by the selector module 20 to be most appropriate. In the present embodiment, the mode validation unit 45 is incorporated into the subsystem controller 14. Alternatively, the mode validation unit 45 may optionally be separate from the subsystem controller 14. In the present embodiment, the override signal 50 implements a change from the manual response mode to the automatic response mode. Alternatively, the override signal 50 may cause the subsystem controller 14 to select the subsystem control mode determined to be most appropriate while continuing to operate in the manual response mode (i.e. without switching to the automatic response mode).

The override signal 50 is generated if the control system is operating in the manual response mode and it is determined that the current subsystem control mode (selected in the manual response mode) is not appropriate or that a different subsystem control mode would be more appropriate. The determination that the current subsystem control mode is not appropriate or that a different subsystem control mode would be more appropriate may be determined in dependence on one or more of the terrain indicators. The subsystem controller 14 switches to the automatic response mode in dependence on the override signal 50. As described herein, the vehicle subsystems 12 are controlled automatically in dependence on one or more of the terrain indicators in the automatic response mode. The subsystem control mode is selected in dependence on the probability analysis described herein.

There now follows a series of examples of how the subsystem controller 14 generates the override signal 50.

### EXAMPLE 1

The control system 100 is operating in the user-selected manual response mode. The vehicle is being driven on-road for an extended period of time in a manually-selected MR mode, GGS mode, Sand mode or RB mode. The selector module 20 evaluates the one or more terrain condition indicators 17 and determines which of the subsystem control modes is appropriate. The selector module 20 generates an output 30 indicating which of the plurality of the subsystem control modes is determined to be most appropriate. The subsystem controller 14 performs a check to determine if the subsystem control mode selected in the manual response mode is the same as the subsystem control mode determined to be most appropriate by the selector module 20. If the manually selected subsystem control mode and the determined subsystem control mode are not consistent, the subsystem controller 14 generates the override signal 50 to override the manually selected subsystem control mode. The subsystem controller 14 controls the switching device 32a to switch from the manual response mode to the automatic response mode and the subsystem control mode determined to be most appropriate is selected, thereby overriding the driver selection. Rather than switch to the automatic response mode, the subsystem controller 14 may directly select the subsystem control mode determined to be most appropriate while remaining in the manual response mode. The activation of the automatic response mode may be inhibited or delayed in one or more of the following states: if Dynamic Stability Control is off (DSC OFF), the vehicle 200 has a trailer detected (trailer status ON) or a fault is set for any critical input to the system. The rationale behind this operation is that if an inappropriate subsystem control mode has been selected by the driver, the vehicle performance is not optimized for on-road performance. The automated selection of the automatic subsystem control mode reduces the likelihood of driver annoyance as the most appropriate subsystem control mode for the conditions will then be selected for the driver automatically.

### EXAMPLE 2

The control system 100 is operating in the user-selected manual response mode. The selector module 20 evaluates the one or more terrain condition indicators 17 and determines which of the subsystem control modes is appropriate. The selector module 20 generates an output 30 indicating which of the plurality of the subsystem control modes is determined to be most appropriate. The subsystem controller 14 performs a check to determine if the subsystem control mode selected in the manual response mode is the same as the subsystem control mode determined to be most appropriate by the selector module 20. If the manually selected subsystem control mode and the determined subsystem control mode are not consistent, the subsystem controller 14 generates the override signal 50 to override the manually selected subsystem control mode. The subsystem controller 14 controls the switching device 32a to switch from the manual response mode to the automatic response mode. The selector module 20 activates the automatic response mode such that one of the plurality of other control modes is selected. For example, the automatic response mode may select one of the following: standard mode, economy mode (often referred to as Eco mode) and sport mode. For example, if the driver has selected sport mode but it is determined from the driving condition indicators that the vehicle has moved from a high speed, sporty environment (e.g. motorway) to a low speed, economy style driving environment (e.g. urban), the subsystem controller 14 may activate the automatic response mode and automatically select the Eco mode in dependence on the probability analysis which indicates that this is the most appropriate subsystem control mode.

For each subsystem control mode that can be selected various ones of the vehicle subsystems will have predetermined settings, or a predetermined range of settings, which are suitable for that particular driving style. For example, in selecting Eco mode or sport mode (or any other subsystem control mode), the vehicle subsystems which may be adjusted to a predetermined setting (or a predetermined range of settings) include the gearbox, the part of the engine control system which includes throttle maps that determine fuel delivery, and the part of the engine control system which includes calibration maps.

The override signal 50 may be generated in dependence on an operating condition or an operating state of the vehicle 200. By way of example, the override signal 50 may be generated in dependence on a determination that the vehicle 200 is in a stuck condition. In use, the vehicle 200 may become stuck (i.e., stuck fast). This is referred to herein as the vehicle 200 being in a stuck condition or a vehicle stuck condition. The vehicle 200 may become stuck if the driving wheels are unable to generate sufficient motive force to propel the vehicle 200. The inability to generate sufficient motive force may be due to a reduced or limited traction available at the driving wheels, for example due to the local terrain conditions. The vehicle 200 may become stuck if there is insufficient traction available at the driving wheels, for example if the vehicle 200 is on terrain having a low surface friction (low ‘mu’), such as wet grass or snow/ice; or if the vehicle 200 becomes mired or bogged down in a deformable terrain, such as mud, sand or snow. Other terrain conditions and/or operating conditions may cause the vehicle 200 to become stuck. The determination that the vehicle is in a stuck condition is distinct from the vehicle 200 being rendered immovable due to a fault or failure, for example in the powertrain. The override signal 50 may be generated if the vehicle 200 is in a stuck condition and the mode validation unit 45 determines that the manually selected subsystem control mode is not consistent with the subsystem control mode determined to be most appropriate by the selector module 20. The determination that the vehicle is in a stuck condition will now be described.

The VCU 10 comprises a control system 60 in the form of a vehicle stuck identification module (VSIM) 60 (see FIG. 6). The VSIM 60 is configured to identify a vehicle stuck condition, i.e., to identify that the vehicle 200 is in a stuck condition. The VCU 10 may optionally identify a vehicle not stuck condition (i.e. that the vehicle is not in a stuck condition) or this may be inferred by the absence of a vehicle stuck condition. The VSIM 60 outputs a vehicle stuck signal 61a to indicate identification of a vehicle stuck condition. The vehicle stuck signal 61a is received by the subsystem controller 14. With the vehicle being in a stuck condition, any switching inhibits may be bypassed, allowing the most appropriate subsystem control mode for the surface and terrain to be automatically selected by the subsystem controller 14.

The vehicle stuck identification module 60 communicates with the estimator module 18 to monitor operation of the vehicle 200 and the vehicle subsystems. The VSIM 60 may be implemented by the one or more electronic processor 5 of the VCU 10. In the present embodiment, the VSIM 60 is described as a separate controller. The VSIM 60 comprises a control system 62 as illustrated in FIG. 6. The control system 62 comprises one controller 63, although it will be appreciated that this is merely illustrative. The controller 63 comprises processing means 64 and memory means 65. The processing means 64 may be one or more electronic processing device 66 which operably executes computer-readable instructions. The memory means 65 may be one or more memory device 67. The memory means 65 is electrically coupled to the processing means 64. The memory means 65 is configured to store instructions, and the processing means 64 is configured to access the memory means 65 and execute the instructions stored thereon. The operation of the VSIM 60 will now be described in more detail.

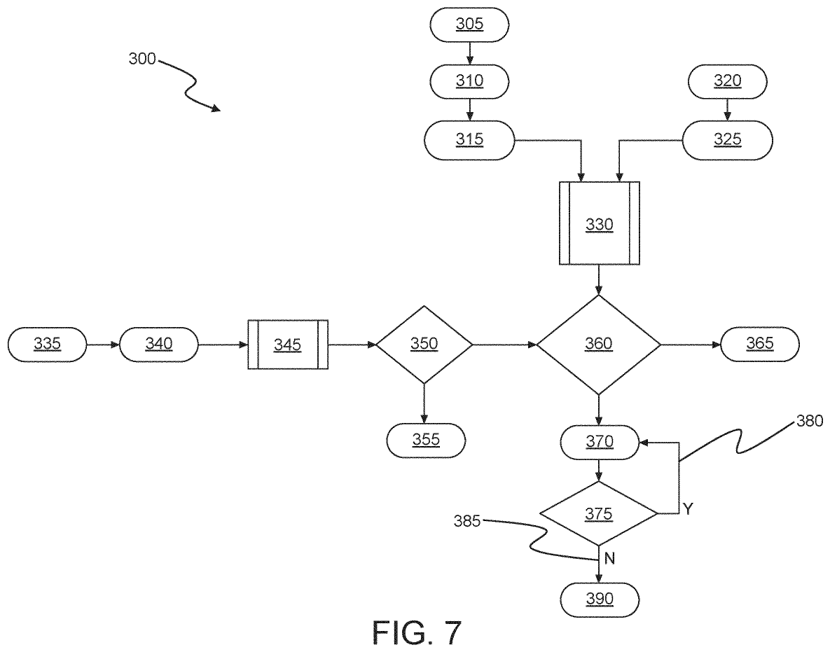

A first flow chart 300 representing the operation of the subsystem controller 14 is shown in FIG. 7. More particularly, the first flow chart 300 illustrates the operation of the mode validation unit 45 to generate an override signal 50 to activate the automatic response mode. In the present embodiment, the override signal 50 is issued in dependence on receipt of the vehicle stuck signal 61a identifying a vehicle stuck condition. The override signal 50 may be generated in dependence on a determination that the vehicle 200 is in a stuck condition (i.e., the vehicle 200 is stuck fast). A driver of the vehicle 200 manually selects the manual response mode (BLOCK 305). The subsystem controller 14 activates the manual response mode in dependence on the driver input (BLOCK 310). The driver manually selects a current subsystem control mode from one of the plurality of predefined subsystem control modes (BLOCK 315). The selector module 20 operates in parallel to assess the suitability of each of the plurality of predefined subsystem control modes (BLOCK 320). The selector module 20 calculates a combined probability value for each subsystem control mode and identifies an appropriate subsystem control mode in dependence on the terrain conditions (BLOCK 325). The selector module 20 generates the output 30 which indicates the subsystem control mode determined to be most appropriate. A check is then made to determine if the current subsystem control mode selected using the manual response mode is the same as or different from the subsystem control mode identified in dependence on the combined probability value (BLOCK 330). The check to assess whether the current subsystem control mode and the determined subsystem control mode are consistent is performed by the mode validation unit 45 in the present embodiment.

As described herein, the VSIM 60 determines if the vehicle 200 is in a stuck condition. The determination that the vehicle 200 is in a stuck condition comprises assessing the current operating conditions of the vehicle 200. The VSIM 60 assesses the environment in which the vehicle 200 is travelling or operating (BLOCK 335). The VSIM 60 may, for example, monitor the driving condition indicators (terrain indicators) to assess the environment. The VSIM 60 also monitors the operating parameters of the vehicle 200 (BLOCK 340). The VSIM 60 is configured to identify a vehicle stuck condition (BLOCK 345), i.e., to identify that the vehicle 200 is in a stuck condition. A check is performed to identify if the vehicle 200 is in a vehicle stuck condition (BLOCK 350). If a vehicle stuck condition is not identified, the (manually selected) current subsystem control mode is maintained (BLOCK 355).

If the VSIM 60 determines that the vehicle 200 is in a stuck condition, the selector module 20 performs a check to determine if the (manually selected) current subsystem control mode is the same as the identified subsystem control mode (BLOCK 360). If the current subsystem control mode and the identified subsystem control mode are the same, the (manually selected) current subsystem control mode is maintained (BLOCK 365). The control system remains in the manual response mode. If the current subsystem control mode and the identified subsystem control mode are different, the subsystem control mode is changed from the manual response mode to the automatic response mode. The automatic response mode is activated, and the identified subsystem control mode is selected (BLOCK 370). The selection of the identified subsystem control mode increases the likelihood of the vehicle 200 being able to self-recover.

While the automatic response mode is active, the VSIM 60 determines if the vehicle 200 remains in the stuck condition (BLOCK 375). If the VSIM 60 determines that the vehicle 200 is still in the stuck condition, the subsystem controller 14 maintains the automatic response mode (FUNCTION 380). If the VSIM 60 determines that the vehicle 200 is not in a stuck condition (i.e., the vehicle 200 is no longer stuck), the subsystem controller 14 changes (switches) from the automatic response mode to the manual response mode (FUNCTION 385). The subsystem controller 14 selects the (manually selected) subsystem control mode in the manual response mode (BLOCK 390).

The vehicle stuck identification module 60 will now be described in more detail. The VSIM 60 receives first wheel speed signals 71 comprising first and second front wheel speed signals 71a, 71b for each of the front wheels W1, W2 of the vehicle 200. The first front wheel speed signal 71a is received from the first front wheel speed sensor 72a; and the second front wheel speed signal 71b is received from the second front wheel speed sensor 72b. The first and second front wheel speed sensors 72a, 72b are associated with respective first and second front wheels W1, W2 of the vehicle 200. The first and second front wheel speed signals 71a, 71b indicate the wheel speeds of the front wheels W1, W2. The VSIM 60 adds the wheel speeds of each of the front wheels W1, W2 to determine a first sum S1. In a variant, the VSIM 60 may receive the first sum S1 from another subsystem or estimator.

The VSIM 60 receives second wheel speed signals 73 comprising first and second rear wheel speed signals 73a, 73b for each of the rear wheels W3, W4 of the vehicle 200. The first rear wheel speed signal 73a is received from a first rear wheel speed sensor 72a; and the second rear wheel speed signal 73B is received from a second rear wheel speed sensor 72b. The VSIM 60 receives first and second rear wheel speed signals 73a, 73b from the first rear wheel speed sensor 74a and the second rear wheel speed sensor 74b. The first and second rear wheel speed sensors 74a, 74b are associated with respective first and second rear wheels (only the second rear wheel W4 is visible in FIG. 1) of the vehicle 200. The first and second rear wheel speed signals 73a, 73b indicate the wheel speeds of the rear wheels W4. The VSIM 60 adds the wheel speeds of each of the rear wheels W4 to determine a second sum S2. In a variant, the VSIM 60 may receive the second sum S2 from another subsystem or estimator.

The VSIM 60 receives the vehicle speed signal SVS indicating the longitudinal speed VLS of the vehicle 200. The longitudinal speed signal SVS in the present embodiment is received from the vehicle speed sensor VSP. The longitudinal speed VLS of the vehicle is determined in dependence on the acceleration measured in a longitudinal direction by the accelerometer 76. Other techniques may be employed to determine the longitudinal speed VLS of the vehicle 200.

The control system 62 is configured to identify a vehicle stuck condition in dependence on a determination that each of the following conditions is satisfied:
i. The longitudinal speed VLS of the vehicle 200 is at least substantially equal to zero or is less than a minimum speed threshold.
ii. One of the first and second sums S1, S2 is substantially equal to zero (0) or is less than or equal to a first threshold value TH1; and the other one of the first and second sums S1, S2 is greater than zero (0) or greater than or equal to a second threshold TH2.

If the above conditions are satisfied, the control system 62 outputs the vehicle stuck signal 61a to the subsystem controller 14. The control system 61 in the present embodiment requires that each of these conditions is satisfied for at least a first time period, the first time period being greater than a predetermined time threshold. The first time period may, for example, be defined as 1 second. The first time period may be less than or greater than 2 seconds. The first time period is a calibratable value and may be determined through testing.

In the present embodiment, the first and second threshold values TH1, TH2 are at least substantially equal to each other. The first and second threshold values TH1, TH2 are both defined as zero (0). Alternatively, the first and second threshold values TH1, TH2 may be greater than zero (0). In a variant, the first and second threshold values TH1, TH2 may be different from each other. At least one of the first and second threshold values TH1, TH2 may be greater than zero (0). One of the first and second threshold values TH1, TH2 may be defined as zero (0); and the other one of the first and second threshold values TH1, TH2 may be defined as a value greater than zero (0). The second threshold value TH2 may be greater than the first threshold value TH1.

The control system 62 may optionally calculate the difference between the first and second sums S1, S2. The calculated difference between the first and second sums S1, S2 may be used as a condition to identify a vehicle stuck condition, i.e. to determine if the vehicle 200 is in a stuck condition. The difference between the first and second sums S1, S2 may be used instead of, or in addition to, the determination that one of the first and second sums S1, S2 is substantially equal to zero (0). In the present embodiment, the identification of a vehicle stuck condition includes the additional requirement that the difference between the first and second sums S1, S2 is greater than a predetermined difference threshold DTH1. The control system 62 is configured identify a vehicle stuck condition in dependence on a determination that the difference between the first and second sums S1, S2 is greater than the predetermined difference threshold DTH1. If the difference between the first and second sums S1, S2 is less than the predetermined difference threshold DTH1, the control system 62 determines that the vehicle 200 is not in a stuck condition. If the difference between the first and second sums S1, S2 is greater than the predetermined difference threshold DTH1, the control system 62 identifies a vehicle stuck condition in dependence on a determination that each of the other conditions is satisfied.

The VSIM 60 may optionally perform a check to determine a requested vehicle braking force. The requested vehicle braking force may be used as a further condition to determine whether or not the vehicle 200 is in a stuck condition. The VSIM 60 may be configured to identify a vehicle stuck condition only when the requested vehicle braking force is substantially equal to zero (i.e., there is substantially no requested vehicle braking force) or the requested vehicle braking force is less than a predetermined braking threshold. The VSIM 60 may determine that the vehicle 200 is not in a stuck condition while there is a requested vehicle braking force. The VSIM 60 in the present embodiment is configured to receive a vehicle braking signal 77b indicating a requested vehicle braking force. The vehicle braking signal 77b in the present embodiment is received from a brake pedal position sensor 78 which indicates a brake pedal position. Alternatively, or in addition, the vehicle braking signal 77b may be received from a braking system controller and/or a handbrake sensor. The requested vehicle braking force is zero (0) when the brake pedal is not depressed. The control system 62 is configured to identify a vehicle stuck condition in dependence on the requirement that the requested vehicle braking force is zero (0) or is less than a predetermined braking threshold. If the vehicle braking force is greater than zero or greater than the predetermined braking threshold, the control system 62 determines that the vehicle 200 is not in a stuck condition. If the vehicle braking force is equal to zero or is less than the predetermined braking threshold, the control system 62 identifies a vehicle stuck condition in dependence on a determination that each of the other conditions is satisfied.

The VSIM 60 may optionally perform a check to determine a currently selected transmission ratio of the transmission 81 in the vehicle driveline. The VSIM 60 may determine which one of the following transmission ratios is currently selected: a forward drive ratio, a reverse drive ratio and a neutral drive ratio. The VSIM 60 may use the selected transmission ratio as a further condition to determine whether or not the vehicle 200 is in a stuck condition. The VSIM 60 may optionally determine that the vehicle 200 is not in a stuck condition while the selected transmission ratio is the reverse drive ratio or the neutral drive ratio. The VSIM 60 in the present embodiment receives a transmission signal 79a identifying which of the transmission ratios is currently selected. The transmission signal 79a may, for example, be output by a transmission control unit 80 for controlling the transmission system 12b. The transmission signal 79a indicates that the current gear is one of: a forward drive ratio, a reverse drive ratio and a neutral drive ratio. The control system 62 is configured to identify a vehicle stuck condition in dependence on the requirement that the currently selected transmission ratio is a forward drive ratio. If the selected transmission ratio is the reverse drive ratio or the neutral drive ratio, the control system 62 determines that the vehicle 200 is not in a stuck condition. If the selected transmission ratio is the forward drive ratio, the control system 62 identifies a vehicle stuck condition in dependence on a determination that each of the other conditions is satisfied.

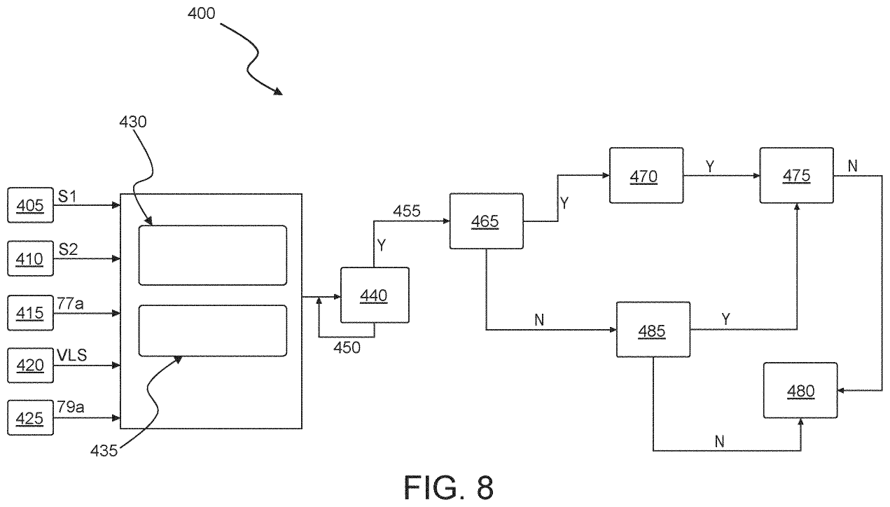

The operation of the VSIM 60 will now be described with reference to a second flow diagram 400 shown in FIG. 8. The VSIM 60 receives the first sum S1 (BLOCK 405) indicating the sum of the front wheel speeds; and the second sum S2 (BLOCK 410) indicating the sum of the rear wheel speeds. The VSIM 60 receives the brake pedal signal 77a (BLOCK 415) representing the requested vehicle braking force. The VSIM 60 receives the longitudinal speed VLS of the vehicle 200 (BLOCK 420). The VSIM 60 receives the transmission signal 79a indicating the current transmission ratio. (BLOCK 425).

The VSIM 60 is configured to identify a vehicle stuck condition if one of a first set of conditions or a second set of conditions is satisfied.

The first set of conditions (BLOCK 430) is defined as follows:
i. The longitudinal speed VLS of the vehicle 200 is substantially equal to zero (0);
ii. The first sum S1 is equal to zero (0) and the second sum S2 is greater than zero (0);
iii. The requested vehicle braking force is zero (0); and
iv. The current selected transmission ratio is a forward drive ratio (not a reverse or neutral drive ratio).

The second set of conditions (BLOCK 435) is defined as follows:
i. The longitudinal speed VLS of the vehicle 200 is substantially equal to zero (0);
ii. The first sum S1 is greater than zero (0) and the second sum S2 is equal to zero (0);
iii. The requested vehicle braking force is zero (0); and
iv. The current selected transmission ratio is a forward drive ratio (not a reverse or neutral drive ratio).

The VSIM 60 initiates a timer (BLOCK 440) to determine if the first set or the second set of conditions is satisfied for the first time period. If the conditions are no longer satisfied after expiry of the first time period, the VSIM 60 determines that the vehicle 200 is no longer stuck. A determination that the vehicle 200 is no longer stuck may, for example, indicate that the vehicle 200 has self-recovered. The VSIM 60 continues to monitor the operation of the vehicle to determine if either the first or second set of conditions is satisfied (FUNCTION 450). If the first or second set of conditions is satisfied after expiry of the first time period, the VSIM 60 determines that the vehicle 200 remains in the stuck condition (FUNCTION 455). The VSIM 60 then subtracts the second sum S2 from the first sum S1 (S1−S2=FRSD) to calculate a front/rear wheel speed difference FRSD. A check is performed to determine if the front/rear wheel speed difference is greater than zero (0) (BLOCK 465).

If the front/rear wheel speed difference is greater than zero (0), the VSIM 60 performs a check to determine if the front/rear wheel speed difference FRSD is greater than a first difference threshold THD1 (FRSD>THD1) and to determine the longitudinal speed VLS of the vehicle 200 remains at least substantially equal to zero (0) (VLAB=0) (BLOCK 470). If the front/rear wheel speed difference FRSD is greater than the first difference threshold THD1 and the longitudinal speed VLS is at least substantially equal to zero (0), the VSIM 60 determines that the vehicle 200 is in the stuck condition (BLOCK 475). The VSIM 60 may set the timer to zero (0) in dependence on the determination that the vehicle 200 is in the stuck condition. If the front/rear wheel speed difference FRSD is less than the first difference threshold THD1 and/or the longitudinal speed VLS is greater than zero (0), the VSIM 60 determines that the vehicle 200 is not in the stuck condition (BLOCK 480).

If the front/rear wheel speed difference is less than zero (0), the VSIM 60 subtracts the first sum S1 from the second sum S2 (S2−S1) to calculate a rear/front wheel speed difference RFSD. The VSIM 60 performs a check to determine if the rear/front wheel speed difference RFSD is greater than a second difference threshold THD2 (RFSD>THD2) and the longitudinal speed VLS of the vehicle 200 remains at least substantially equal to zero (0) (BLOCK 485). If the rear/front wheel speed difference RFSD is greater than the second difference threshold THD2 and the longitudinal speed VLS is at least substantially equal to zero (0), the VSIM 60 determines that the vehicle 200 is in the stuck condition (BLOCK 475). The VSIM 60 may set the timer to zero (0) in dependence on the determination that the vehicle 200 is in the stuck condition. If the rear/front wheel speed difference RFSD is less than the second difference threshold THD2, and/or the longitudinal speed VLS is greater than zero (0), the VSIM 60 determines that the vehicle 200 is not in the stuck condition (BLOCK 480). The first and second difference thresholds THD1, THD2 may be the same as each other or may be different from each other.

If the VSIM 60 determines that the vehicle 200 is in a stuck condition, the control system 62 generates the vehicle stuck signal 61a to identify a vehicle stuck condition. The vehicle stuck signal 61a is output to the subsystem controller 14. The subsystem controller 14 determines if the manual response mode or the automatic response mode is currently selected. If the manual response mode is currently selected, the mode validation unit 45 performs a check to determine if the manually selected subsystem control mode is consistent with the subsystem control mode determined to be most appropriate by the selector module 20. If the subsystem control modes are not consistent, the override signal 50 is generated to switch from the manual response mode to the automatic response mode. As described herein, the subsystem controller 14 switches from the manual response mode to the automatic response mode. The selector module 20 determines which subsystem control mode is appropriate in dependence on the one or more of the terrain condition indicators 17. For example, the selector module 20 may select a subsystem control mode which provides increased traction. The output 30 from the selector module 20 is sent to the subsystem controller 14 to indicate the subsystem control modes determined to be most appropriate. The subsystem controller 14 switches from the manual response mode to the automatic response mode. The subsystem control mode determined by the selector module 20 to be most appropriate is selected automatically in the automatic response mode.

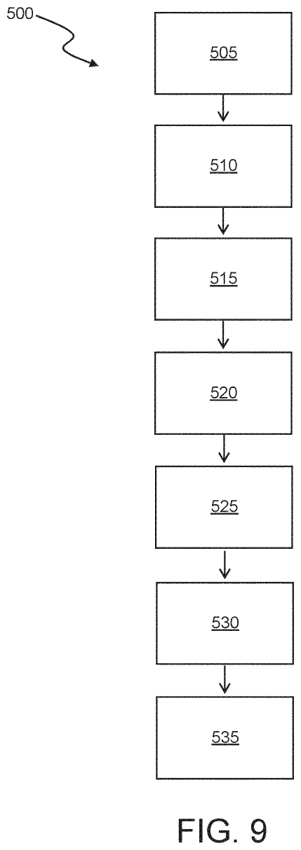

FIG. 9 illustrates a method 500 according to an embodiment of the invention. The method 500 is a method of controlling operation of a vehicle, such as the vehicle 200 illustrated in FIG. 1. In particular, the method 500 is a method of controlling operation of at least one vehicle subsystems 12. The method 500 may be performed by the VCU 10 illustrated in FIG. 2. In particular, the memory means 4 may comprise computer-readable instructions which, when executed by the processing means 3, perform the method 500 according to an embodiment of the invention.

As illustrated in FIG. 9, the method 500 comprises controlling the at least one vehicle subsystem 12 in a plurality of subsystem control modes (BLOCK 505). Each of the subsystem control modes is suitable for operating the vehicle 200 in a particular terrain type. The method comprises selecting one of a manual response mode and an automatic response mode (BLOCK 510). In the manual response mode, one of the subsystem control modes is selected manually by a user. In the automatic response mode, an appropriate one of the subsystem control modes is selected automatically. The method comprises determining at least one terrain condition indicator (BLOCK 515). The at least one terrain condition may, for example, be derived from data collected by one or more vehicle detection system (VDS) and/or one or more vehicle sensor system (VSS). The at least one terrain condition indicator is evaluated to determine the extent to which each of the subsystem control modes is appropriate (BLOCK 520). A determination is made as to which of the subsystem control modes is most appropriate (BLOCK 525). When the automatic response mode is selected, the subsystem control mode determined to be most appropriate is selected automatically (BLOCK 530). The method comprises operating in the automatic response mode if a subsystem control mode has been selected by the driver in the manual response mode which is not consistent with the subsystem control mode determined to be most appropriate (BLOCK 535). The method may comprise automatically switching from the manual response mode to the automatic response mode.

The VCU 10 in the present embodiment has been described with reference to the identification and selection of a subsystem control mode in dependence on a determination that the vehicle 200 is in the stuck condition. Alternatively, or in addition, the VCU 10 may be configured to control the one or more vehicle subsystem 12 directly. The VCU 10 may be configured to control the one or more vehicle subsystem 12 with or without a change in the subsystem control mode. For example, one or more vehicle subsystem 12 may be controlled in dependence on a determination that the vehicle 200 is in the stuck condition. The one or more vehicle subsystem 12 may comprise one or more of the following: the propulsion (or engine) management system 12a, the transmission system 12b, the steering system 12c, the brakes system 12d, the suspension system 12e and the differential system 12f.

The VCU 10 may be configured to control the differential system 12f in dependence on a determination that the vehicle 200 is in the stuck condition The one or more differential 83 may be closed (i.e. locked) in dependence on a determination that the vehicle 200 is in the stuck condition. For example, the VCU 10 may be configured to lock the centre differential 83 in dependence on a determination that the vehicle 200 is in the stuck condition. Alternatively, or in addition, the VCU 10 may be configured to control the transmission system 12b in dependence on a determination that the vehicle 200 is in the stuck condition. For example, the VCU 10 may be configured to change a transmission map implemented by the transmission system 12b in dependence on a determination that the vehicle 200 is in the stuck condition. The VCU 10 may be configured to control the transmission 81 to select a low drive ratio in dependence on a determination that the vehicle 200 is in the stuck condition. Alternatively, or in addition, the VCU 10 may be configured to control the transfer case 82 to engage a low range in dependence on a determination that the vehicle 200 is in the stuck condition. Alternatively, or in addition, the VCU 10 may be configured to control the suspension system 12e to adjust a suspension height in dependence on a determination that the vehicle 200 is in the stuck condition. For example, the VCU 10 may be configured to control the suspension system 12e to raise one or more of the suspension units S1-4 in dependence on a determination that the vehicle 200 is in the stuck condition. Alternatively, or in addition, the VCU 10 may be configured to control the propulsion (or engine) management system 12a in dependence on a determination that the vehicle 200 is in the stuck condition. For example, the VCU 10 may be configured to change a torque generating map implemented by the propulsion (or engine) management system 12a. The one or more vehicle subsystem may be controlled by the VCU 10 or by separate control units provided in the vehicle 200.

Other control strategies are contemplated in dependence on a determination that the vehicle 200 is in a stuck condition. For example, the VCU 10 may be configured to select a low range mode in dependence on the determination that the vehicle 200 is in the stuck condition. The low range mode may comprise activating one or more of the following: a hill descent control, a traction control, a dynamic control, a propulsion management system, and a suspension height adjustment.

It will be appreciated that various changes and modifications can be made to the present invention without departing from the scope of the present application.

1. A system for a vehicle having at least one vehicle subsystem, the system comprising:
a subsystem controller for controlling at least one vehicle subsystem in a plurality of subsystem control modes, each of which control modes corresponds to one or more different terrain types for the vehicle;
a switching device for switching between a manual response mode in which one of the subsystem control modes is selected manually and an automatic response mode in which the subsystem controller automatically selects an appropriate subsystem control mode;
one or more of a vehicle detection system and a vehicle sensor system for generating a signal from which at least one terrain condition indicator is derived; and
a processor configured to evaluate the at least one terrain condition indicator to determine the extent to which each of the subsystem control modes is appropriate and for providing an output indicative of the subsystem control mode which is most appropriate, wherein the subsystem controller is operable in the automatic response mode to select a subsystem control mode in dependence on the output, and wherein the system is operable to operate in the subsystem control mode determined to be most appropriate if a subsystem control mode has been selected by a driver in the manual response mode which is not consistent with the subsystem control mode determined to be most appropriate.

2. A system according to claim 1, wherein the system is operable to switch to the automatic response mode and to select the subsystem control mode determined to be most appropriate if the subsystem control mode selected by the driver in the manual response mode is not consistent with the subsystem control mode determined to be most appropriate.

3. A system according to claim 2, wherein the system is operable to switch from the automatic response mode back to the manual response mode upon expiry of a predetermined time period.

4. A system according to claim 2, wherein the system is operable to switch from the automatic response mode back to the manual response mode upon a determination by the processor that the subsystem control mode selected by the driver in the manual response mode is consistent with the subsystem control mode selected determined to be most appropriate.

5. A system according to claim 1, wherein the subsystem controller is configured to monitor an operating condition of one or more vehicle subsystems activated in the subsystem control mode selected by the driver in the manual response mode.

6. A system as claimed in claim 5, wherein the system is operable to select the subsystem control mode determined to be most appropriate in dependence on a determination that the monitored operating condition is outside a predetermined operating range.

7. A system according to claim 1, wherein the system is configured to identify a vehicle stuck condition.

8. A system according to claim 7, wherein the subsystem controller is configured to determine that the vehicle is in a stuck condition when each of the following conditions is satisfied:
i. A longitudinal speed of the vehicle is substantially equal to zero; and
ii. One of a first sum and a second sum is equal to zero or is less than a first threshold; and the other one of the first sum and the second sum is greater than zero or is greater than a second threshold; wherein the first sum is the sum of front wheel speeds and second sum is the sum of the rear wheel speeds.

9. A system according to claim 7, wherein the system is configured to operate in the subsystem control mode determined to be most appropriate while the vehicle stuck condition is identified; and to operate in the subsystem control mode selected by the driver when the vehicle stuck condition is not identified.

10. A vehicle comprising a system according to claim 1.

11. A vehicle control unit for controlling at least one vehicle subsystem of a vehicle in a plurality of subsystem control modes, each of which corresponds to one or more different terrain types for the vehicle, the vehicle control unit being configured to:
receive a signal from one or more vehicle sensors;
derive from the signal at least one terrain condition indicator; and
evaluate the at least one terrain condition indicator to determine the extent to which each of the subsystem control modes is appropriate;
wherein the vehicle control unit is operable in an automatic response mode to select a subsystem control mode in dependence on the subsystem control mode which is determined to be the most appropriate; wherein the vehicle control unit is switchable from the automatic response mode to a manual response mode in which the subsystem control mode is selected by the driver manually; and
wherein the vehicle control unit is configured to operate in the subsystem control mode determined to be most appropriate if a subsystem control mode has been selected by the driver in the manual response mode which is not consistent with the subsystem control mode determined to be the most appropriate.

12. A vehicle control unit according to claim 11, wherein the vehicle control unit is configured to switch to the automatic response mode and to select the subsystem control mode determined to be most appropriate if the subsystem control mode selected by the driver in the manual response mode is not consistent with the subsystem control mode determined to be most appropriate.

13. A method of controlling operation of at least one vehicle subsystem of a vehicle, the method comprising:
controlling the at least one vehicle subsystem in a plurality of subsystem control modes, each of the subsystem control modes corresponding to one or more different terrain types for the vehicle;
selecting one of a manual response mode for manually selecting one of the subsystem control modes and an automatic response mode in which an appropriate one of the subsystem control modes is selected automatically;
determining at least one terrain condition indicator; and
evaluating the at least one terrain condition indicator to determine the extent to which each of the subsystem control modes is appropriate and determining which of the subsystem control modes is most appropriate and automatically selecting the subsystem control mode determined to be most appropriate when the automatic response mode is selected;
wherein the method comprises operating in the subsystem control mode determined to be most appropriate if a subsystem control mode has been selected by the driver in the manual response mode which is not consistent with the subsystem control mode determined to be most appropriate.

14. A method according to claim 13 comprising switching from the manual response mode to the automatic response mode, the subsystem control mode determined to be most appropriate being implemented automatically when operating in the automatic response mode.

15. A non-transitory computer-readable medium having a set of instructions stored therein which, when executed, cause a processor to perform the method according to claim 13.
